(19) United States
(12) Patent Application Publication
(10) Pub. No.: US 2009/0254270 A1
(43) Pub. Date: Oct. 8, 2009

(54) System and method for tracking a path of a vehicle

(75) Inventor: Xiaoguang Yu, Wuhan (CN)

Correspondence Address: PATENT PROSECUTION;O2MIRCO , INC., 3118 PATRICK HENRY DRIVE, SANTA CLARA, CA, 95054, US

(73) Assignee: O2Micro, Inc.

(21) Appl. No.: 12/080,305

(22) Filed: Apr. 2, 2008

(51) Int. Cl. G01C 21/26; G07B 13/00

(52) U.S. Cl. 701/208; 235/30 R; 701/207; 701/220; 701/213

(57) ABSTRACT

A vehicle charge meter for tracking a path of a vehicle is described. The vehicle charge meter comprises a receiver, a memory, a local controller, and a receipt documentation device. The receiver, the memory, and the receipt documentation device are all coupled to the local controller. The receiver is used for receiving RF signals and extracting positioning data from the signals. The memory includes a database storing relationships between positioning data and toponyms. The local controller is then used for retrieving at least one toponym corresponding to the extracted positioning data. As such, the receipt documentation device can document the retrieved toponym in an electronic receipt or on a paper receipt.

### TECHNICAL FIELD

Embodiments of the present invention relate to an apparatus and method for tracking a traveling path of a vehicle, and more particularly to a vehicle charge meter which can document or print out toponyms of points of interest of the traveling path.

### BACKGROUND ART

Vehicles provide our lives with convenient and efficient transportation facilities. Public vehicles, such as taxies and public buses, also play an important role in transportation. Most taxi proprietors charge according to the distance (mileage) traveled and waiting time. A taximeter, for example, including a mileage meter, an odometer and a timer, is employed in a taxi to record the traveling distance of the taxi. Typically, the taximeter senses not only the rotating speed of a vehicle tire, but also the traveling time and waiting time. As such, the traveling distance can be calculated by multiplying the circumference of the vehicle tire by the sensed rotating speed and the sensed traveling time, and a vehicle charge meter in the taxi can calculate the total charge fee. A charge standard stipulated by a taxi administration headquarters usually includes the aforementioned two factors: traveling distance and waiting time. Furthermore, other aspects, such as time of day (daytime or midnight), day of week (workday or weekend), route taken, destination (downtown or suburb), initial fee, and surcharge (additional fee for fuel, personal call, luggage, etc.), may also be considered in the charge standard.

In addition to the aforementioned functions, the vehicle charge meter may also offer various other functions, such as printing receipts, charge mode programmability, automatic voice prompt, clock and calendar, daily report and so on. However, in practice, consumers need more information for protecting their rights and interests. For example, a taxi passenger may want to know whether the driver selected an optimal path and whether the fare charged by the driver is reasonable or not.

### SUMMARY

A receipt showing names of the places where a passenger gets on and off a taxi and that the taxi passes by is needed. Nevertheless, a conventional vehicle charge meter may print out a receipt only showing a traveling time, a traveling distance and a total charge fee. It is an object of the present invention to provide an apparatus and method for accurately tracking a path of a vehicle and providing a printed note or an electronic file for showing the path in a cost effective manner.

In order to achieve the above object, the present invention provides a vehicle charge meter for tracking a path of a vehicle by documenting toponyms of the path in an electronic receipt or on a paper receipt. The vehicle charge meter comprises a receiver, a memory, a local controller, and a receipt documentation device. The receiver, the memory, and the receipt documentation device are all coupled to the local controller. The receiver is used for receiving RF signals and extracting positioning data from the signals. The memory includes a database storing relationships between positioning data and toponyms. The local controller is then used for retrieving at least one toponym corresponding to the extracted positioning data. As such, the receipt documentation device can document the retrieved toponym in an electronic receipt or on a paper receipt.

### BRIEF DESCRIPTION OF THE DRAWINGS

Other objects, advantages, and novel features of the invention will become more apparent from the following Detailed Description when taken in conjunction with the accompanying drawing.

FIG. 1 is a block diagram of a system for tracking a path of a vehicle, in accordance with one embodiment of the present invention.

FIG. 2 is a block diagram of another system for tracking a path of a vehicle, in accordance with one embodiment of the present invention.

FIG. 3 is a block diagram of a vehicle charge meter mounted in the vehicle of the system described in FIG. 1, in accordance with one embodiment of the present invention.

FIG. 4 is a block diagram of a vehicle charge meter mounted in the vehicle of the system described in FIG. 2, in accordance with one embodiment of the present invention.

FIG. 5 is a flowchart showing a method for tracking a path of a vehicle by a vehicle charge meter mounted in the vehicle, in accordance with one embodiment of the present invention.

FIG. 6 is a flowchart showing an initialization process of the vehicle charge meter, in accordance with one embodiment of the present invention.

FIG. 7 is a flowchart showing a method for parsing a toponym by a remote server cooperating with a transceiver of a vehicle, in accordance with one embodiment of the present invention.

FIGS. 8A and 8B are frame formats of exchange data between the vehicle charge meter and the remote server, in accordance with one embodiment of the present invention.

### DETAILED DESCRIPTION

Reference will now be made in detail to the embodiments of the present invention, system and method for tracking a path of a vehicle. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

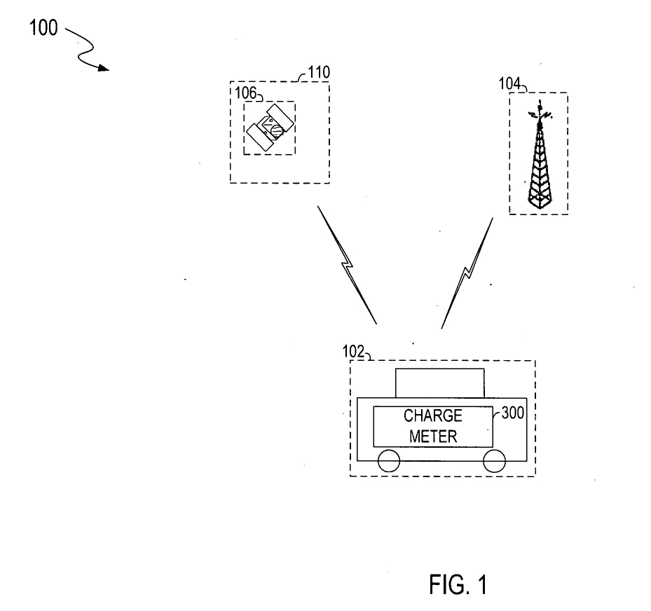

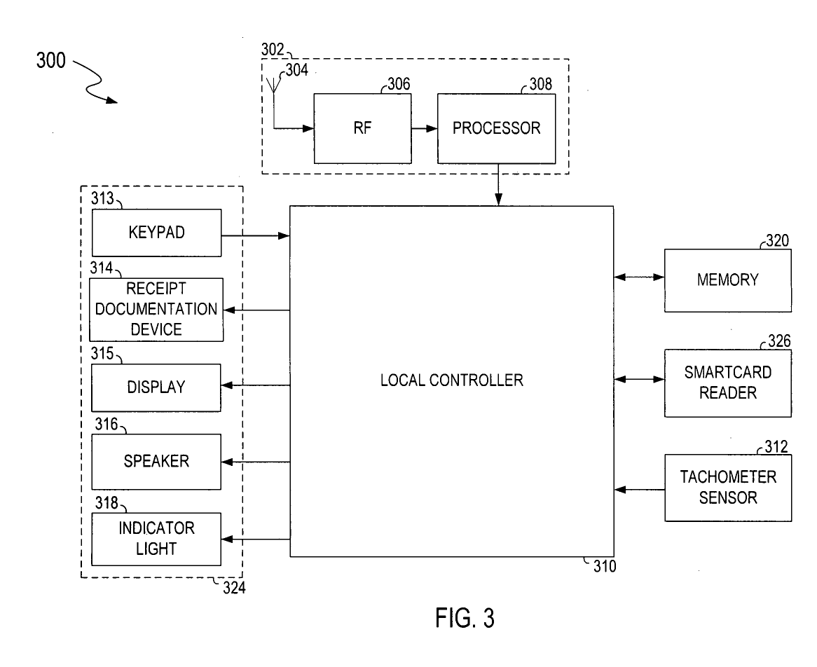

Referring to FIG. 1, a vehicle path tracking system 100 according to one embodiment of the present invention is illustrated. The system 100 comprises a satellite constellation 110 and many client vehicles. For clarity, only a satellite 106 and a vehicle 102 are shown in the FIG. 1 and will be described hereinafter as examples. The satellite constellation 110 including a set of satellites, e.g., the satellite 106, continuously broadcast satellite signals which carry positioning data on a specified radio frequency (RF) carrier. In one embodiment, the client vehicle 102 comprises a vehicle charge meter 300 to receive the satellite signals, extract and process the positioning data, retrieve corresponding human-readable toponyms, and then document these toponyms in an electronic receipt or on a paper receipt. The vehicle charge meter 300 will be described in detail with reference to FIG. 3.

In accordance with one embodiment of the present invention, the satellite constellation 110 is a Global Positioning System (GPS) satellite constellation broadcasting GPS signals, and the vehicle 102 is equipped with a GPS receiver to receive the GPS signals. In one embodiment, the GPS receiver can be installed in the vehicle charge meter 300. The GPS receiver allows the vehicle charge meter 300 to pinpoint the precise location of the vehicle 102. The GPS satellite constellation 110 includes more than 24 satellites (31 up to now) locating in six orbital planes, and there can be four satellites visible at any given time and place on the earth surface. By observing four satellites, e.g., the satellite 106, of the GPS constellation 110 synchronously, the geodetic coordinates of the vehicle 102 can be obtained.

A GPS signal comprises RF carrier, ranging code, and data code. The ranging code and data code are phase-modulated on the RF carrier with a particular frequency. The ranging code is a family of binary pseudorandom noise (PRN) code sequences (pseudorandom code), which is used to identify the satellite 106 and measure distance from the satellite 106 to the vehicle 102. The GPS signal carries two series of ranging code: Coarse Acquisition code (C/A code) and Precision code (P-code). The C/A code is originated from an accurate atomic clock installed in the satellite 106. A matching C/A code can be generated from a clock installed in the GPS receiver of the vehicle charge meter 300 of the vehicle 102. The GPS receiver is then able to match or correlate the C/A code extracted from the received GPS signal so as to generate the matching C/A code. In this way, the time taken for the GPS signal to travel from the satellite 106 to the vehicle 102 can be calculated and then the distance between the satellite 106 and the vehicle 102 can be calculated. This calculated distance is called pseudorange.

The data code of the GPS signal contains navigation message of the satellite 106. The navigation message includes clock adjustment parameters, ephemeris, almanac, and so on. The ephemeris indicates the current date and time, orbital parameters and health status of the satellite 106 when the GPS signal is broadcasted. Based on the ephemeris, the geodetic coordinates and velocity of the satellite 106 can be computed. The almanac gives an approximate estimation of orbital parameters for the satellites in the constellation 110.

The positioning data of the vehicle 102 can be extracted from the ranging code and data code of the GPS signals broadcasted by the satellites of the satellite constellation 110. As mentioned above, the position of the vehicle 102 can be determined by receiving the GPS signals from four satellites. The GPS receiver of the vehicle 102 receives the GPS signals, and then the geodetic coordinates of the four satellites and their pseudoranges to the vehicle 102 can be calculated. As such, four trigonometric equations can be established and three unknown parameters of the geodetic coordinates (latitude, longitude, and altitude), or the positioning data, of the vehicle 102 can be determined.

In this embodiment, the vehicle 102 is provided with a toponym database which includes relationships between positioning data and toponyms. Specific positioning data (geodetic coordinates) which are correspondent to a specific position are correspondent to a unique corresponding toponym. The corresponding toponym can be retrieved from the database according to the positioning data.

In another embodiment, P-code can be used for achieving better precision. And in still another embodiment, enhanced calculation techniques like Differential GPS (DGPS) can be used. For DGPS, a special device positioned at a precisely-surveyed location called a differential beacon (not shown in FIG. 1) is needed. The differential beacon receives GPS signals from the satellite constellation 110 and computes a position of the beacon by means of the GPS signals. Pseudorange correction data can be calculated based on difference between its precisely-surveyed position and the computed position. The pseudorange correction data is then broadcasted. The GPS receiver of the vehicle 102 receives and employs the pseudorange correction data as supplementary information to improve positioning or navigation accuracy. Furthermore, in other embodiments, various algorithms can be used to assist the estimation of other positioning or navigation parameters, such as the moving speed of the vehicle 102.

In accordance with other embodiments of the present invention, other global satellite navigation and positioning systems instead of the GPS can be applied to the satellite constellation 110. The aforementioned positioning theory based on the GPS system, which is developed by the U.S. Department of Defense and based on Code Division Multiple Access (CDMA) technology, can also be applied to other global satellite navigation and positioning systems, such as Galileo developed by the European Union and also based on CDMA technology, Global Navigation Satellite System (GLONASS) developed by Russia but based on Frequency Division Multiple Access (FDMA) technology, or BD-1 developed by China.

Besides GPS and other global satellite navigation and positioning systems, Location Based Service (LBS), also called Location Service (LCS), is an alternative positioning technology in another embodiment. Referring back to FIG. 1, a set of cell sites (base stations) including a cell site 104 are utilized for LBS, and the vehicle 102 is equipped with a LBS receiver, such as a cellular phone for sending tracking commands to the cell sites and receiving LBS signals from the cell sites. The LBS receiver can be installed in the vehicle 102 as a part of the vehicle charge meter 300. The set of cell sites can be built as a local cellular network to broadcast LBS signals containing positioning data which may be provided by either a telecommunication company or a third party.

LBS can be provided through various technologies, such as Cell of Origin (COO) technology, Time of Arrival (TOA) or Angle of Arrival (AOA) technology, and Enhanced Observed Time Difference (E-OTD) technology, for obtaining the positioning data of an object. In one embodiment, according to the COO technology, when the LBS receiver of the vehicle 102 receives a LBS signal from one cell site, for example, the cell site 104, in the cellular network the cell site 104 is the nearest cell site, because a LBS signal from the nearest cell site is the strongest and can be most easily detected by the LBS receiver of the vehicle 102. As such, the rough location of the vehicle 102 is known since the location of the cell site 104 is known. The accuracy thereof depends primarily on the density of the cellular network.

In another embodiment, E-OTD technology is used for LBS. The vehicle 102 is installed with E-OTD software. When LBS signals from three of the cell sites are received by the vehicle 102, the time differences of arrival of the LBS signals at the vehicle 102 are calculated. The time differences are combined to produce intersecting hyperbolic lines so as to estimate the location of the vehicle 102.

In another embodiment, a receiver in the vehicle 102 is able to receive both GPS signals from the satellite constellation 110 and LBS signals from a set of Global System for Mobile Communications (GSM) cell sites to form a hybrid system or Assisted GPS (AGPS) and to determine the location of the vehicle 102. The LBS signals from the set of GSM cell sites (including the cell site 104) serve as assistances to the GPS signals from the GPS constellation 110. The AGPS can employ the vehicle 102 for location computation, or can employ the cell sites for remote computation for the vehicle 102. In another embodiment, a receiver in the vehicle 102 is able to receive GPS signals from the satellite constellation 110 and LBS signals from a set of Code Division Multiple Access (CDMA) cell sites to form another hybrid system or GPSONE instead of AGPS.

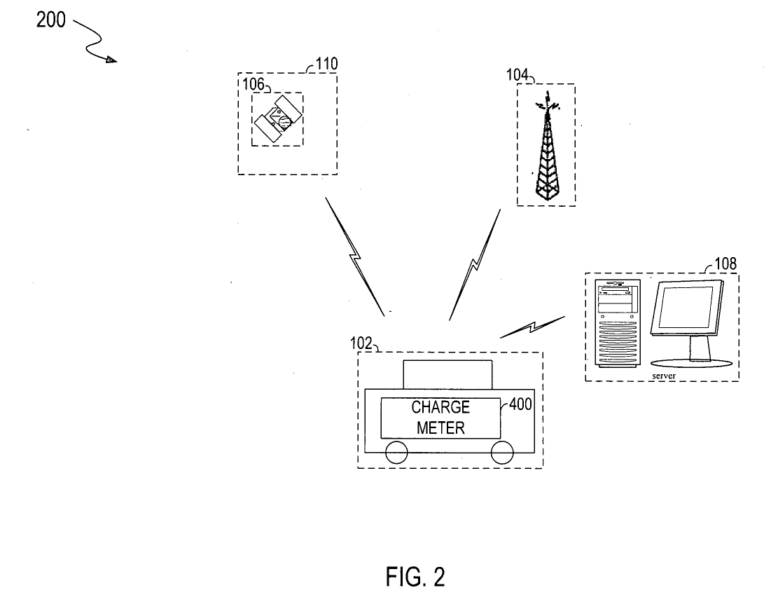

Referring to FIG. 2, another vehicle path tracking system 200 according to one embodiment of the present invention is illustrated. A remote server 108 is used for parsing toponyms of points of interest (POIs). For clarity, those elements of the vehicle path tracking system 200 with the same element number as described above will not be described hereinafter in detail. After receiving and extracting the GPS or LBS signals, the vehicle 102 will transmit the positioning data to the remote server 108 to retrieve corresponding toponyms. A wireless communication device such as a transceiver (not shown in FIG. 2) is mounted on the vehicle 102 to communicate with the remote server 108. The vehicle charge meter 300 in the vehicle 102 can preprocess the received GPS or LBS signals into computer-readable digital positioning data, such as geodetic coordinates of longitude, latitude and altitude as mentioned hereinabove. Through the transceiver, the vehicle 102 sends the preprocessed positioning data to the remote server 108 with a tracking command. The remote server 108 receives and confirms the tracking command, and parses the positioning data from the vehicle 102. The remote server 108 further has a database including mapping relationships between the positioning data and their corresponding toponyms. The toponym can be a name of a community or block, even a name of, for example, a specific restaurant or department store, depending on the extent of the database details. By means of the database, the remote server 108 retrieves corresponding toponyms according to the extracted positioning data. Then, the toponyms as a part of a tracking response are sent back to the vehicle 102 from the remote server 108 through the wireless communication. In one embodiment, the remote server 108 can be an Intelligence Transportation System (ITS).

The wireless communication established between the remote server 108 and the vehicle 102 can comply with various messaging protocols, such as TCP/IP protocol and mobile GSM/CDMA protocol. The TCP/IP protocol further includes Wireless Local Area Network (WLAN) TCP/IP protocol, Wireless Wide Area Network (WWAN) TCP/IP protocol and Internet. WLAN can be WiFi, WiMAX, Bluetooth, etc., which can be applied to the region for establishing the wireless communication. In another embodiment, the wireless communication between the remote server 108 and the vehicle 102 can be established through mobile GSM/CDMA protocol. For example, the remote server 108 can communicate with the vehicle 102 through Short Message Service (SMS), Enhanced Message Service (EMS), or packet oriented General Packet Radio Service (GPRS) technology. Moreover, a 3G technology, such as Telecommunications System (UMTS) or Enhanced Data-Rates for GSM Evolution (EDGE), can also be applied for establishing the wireless communication. Communication through Multimedia Messaging Service (MMS) is also an example of such 3G-based technology.

In accordance with one further embodiment of the present invention, the set of cell sites can be used to provide toponyms to the vehicle 102. The vehicle 102 communicates with the remote server 108 through the set of cell sites. The positioning data is transmitted from the vehicle 102 to the set of cell sites and then transmitted to the remote server 108 through a network, not shown, such as the Internet or a LAN (Local Area Network). Consequently, the complexity of the vehicle charge meter 300 in the vehicle 102 can be reduced.

Referring to FIG. 3, the vehicle charge meter 300 for tracking a path of a vehicle according to one embodiment of the present invention is illustrated. The vehicle charge meter 300 is mounted in the vehicle 102 of the path tracking system 100 shown in FIG. 1. In this embodiment, the vehicle charge meter 300 comprises a toponym database and is able to parse toponyms itself. The vehicle charge meter 300 comprises a receiver 302, a local controller 310, a tachometer sensor 312, a memory 320, a smartcard reader 326, and an I/O block 324.

As shown in FIG. 3, the receiver 302 includes an antenna 304, a RF front-end 306, and a signal processor 308. As introduced above, the satellite constellation or the LBS cell sites broadcast signals at a specified RF carrier. The receiver 302 receives signals from satellite constellation or LBS cell sites, and converts those RF signals into computer-readable digital data so as to extract positioning data of the vehicle 102. The antenna 304 receives the RF signals, and converts the RF signals into electric signals that can be handled by the RF front end 306. The electric signals are then transmitted to the RF front end 306. In one embodiment, the antenna 304 associated with a Low-Noise-Amplifier (LNA) for boosting the level of the signals can be an omni-directional microstrip antenna. The RF front-end 306 coupled to the antenna 304 combines the electric signals with a sinusoidal signal generated by an oscillator (not shown) to generate Intermediate Frequency (IF) signals. The IF signals can be digitally sampled to raw data. The signal processor 308 coupled to the RF front-end 306 decodes the raw data and correlates them to formulate geodetic coordinates (latitude, longitude and altitude) of the location of the receiver 302, e.g., the coordinates of the vehicle 102. Then, the signal processor 308 outputs the geodetic coordinates as positioning data to the local controller 310 for further processing. In one embodiment, the signal processor 308 can be a Digital Signal Processor (DSP) chip. Those skilled in the art will appreciate that for tracking the codes and carriers of the signals, the receiver 302 may include multiple tracking channels designated for particular satellites and frequencies of the signals. Before processing, the signals can be separated into different tracking channels of the receiver 302.

The local controller 310 is a “kernel” of the whole vehicle charge meter 300, which can be a general-purpose Central Processing Unit (CPU), Micro Control Unit (MCU), Micro Processor Unit (MPU), DSP, Advanced RISC Machines (ARM), Microprocessor without Interlocked Pipeline Stages (MIPS), or the like. The local controller 310 manipulates the other modules of the vehicle charge meter 300 to cooperate with each other efficiently, but also parses toponyms of places the vehicle 102 passed by and calculates the traveling distance, the total charge fee, and other information. The positioning data extracted from the receiver 302 can be processed by the local controller 310. In this process, various GPS positioning theories, surveying adjustment, error processing, and some statistic algorithms can be applied by the local controller 310 for optimizing the positioning data. In order to obtain toponyms, the local controller 310 can utilize a database to convert the positioning data into a toponym. In other words, standard geodetic coordinates as the positioning data can be converted into a human-recognizable name of a regional place. In one embodiment, the database including mapping relationship between the positioning data and toponyms is preloaded in the vehicle charge meter 300. In one embodiment, particular positioning data (geodetic coordinates) will be correspondent to a unique corresponding toponym in the database.

The tachometer sensor 312 coupled to the local controller 310 detects velocity of the vehicle 102, from which the traveling distance and the total fare can be computed by the local controller 310. When the vehicle charge meter 300 is initially set and the tachometer sensor 312 is actuated, the tachometer sensor 312 starts to detect velocity of the vehicle 102 and output velocity data to the local controller 310. In one embodiment, the tachometer sensor 312 measures the rotating speed of the vehicle tires to determine the velocity of the vehicle 102.

The I/O block 324 including input and output devices are controlled by the local controller 310. As shown in FIG. 3, the I/O block 324 can include a keypad 313, a receipt documentation device 314, a display 315, a speaker 316 and an indicator light 318. The keypad 313 serving as an input device delivers the operator's commands, such as initializing the vehicle charge meter 300, marking points of interest (POIs), documenting toponyms and printing out a receipt, to the local controller 310. The keypad 313 can be replaced by a keyboard, a mouse, a touchpad or a joystick, in accordance with embodiments of the present invention.

The receipt documentation device 314, the display 315, the speaker 316 and the indicator light 318 work as output devices and output the corresponding information in response to the local controller 310. The receipt documentation device 314 can generate the electronic receipt or print out the paper receipt for the journey; the display 315 can show parsed toponyms; the speaker 316 can give instantaneous voice prompt of POIs during the journey; and the indicator light 318 can show occupation status of the vehicle 102. In general, the receipt documentation device 314 produces a record of the receipt that may be printed on paper in the vehicle 102, or stored in an electronic format for subsequent review and printing. For example, the electronic receipt can be formed as a computer-readable .doc or .txt file and downloaded to a mass storage device like a PDA, a smart phone, a USB flash disk, etc., or sent to a mobile phone as a SMS text message.

The memory 320 can temporarily store system software, application software, the database, parsed toponyms during processing as well as other data in one embodiment. System software, also called an Operating System (OS), such as Vx work, Palm OS, QNX, Windows CE, etc., can be stored in non-volatile memory of the memory 320. The system software may allow multiple software tasks manipulated by different applications. Application software can be preloaded in the memory 320 whenever in need. The database including relationships between the positioning data and toponyms loaded in the memory 320 can be either installed manually by the driver or downloaded from an administration headquarters. However, the database can also be stored in an extra memory besides memory 320 according to a different application.

In accordance with one embodiment of the present invention, a smart card reader 326 is coupled to the local controller 310 for allowing cashless payment. The smart card reader can be automatically set according to the calculated total charge fee, such that the driver need not manually input the number of the total charge fee.

The path tracking process of the vehicle charge meter 300 according to one embodiment of the present invention will be described hereinafter in detail. At first, when a journey commences, the driver as an operator presses a button on the keypad 313 to startup and initialize the vehicle charge meter 300. After the initialization, all the modules in the vehicle charge meter 300 are set ready for work. The tachometer sensor 312 is turned on and starts to count the traveling distance. Previous records and temporary variables in the memory 320 are cleared. The speaker 316 and display 315 are reset. The indicator light 318 is turned off indicating occupation of the vehicle 102. The smart card reader 326 is reset for another payment. Also, the toponym of the start place where the passenger gets on the vehicle 102 is produced. The toponym is parsed from corresponding positioning data of the start place. The positioning data are extracted from signals received at the start place. According to different embodiments, the receiver 302 can accept and process signals from a GPS satellite constellation, or from LBS cell sites. As mentioned above, the receiver 302 converts the received signals into computer-readable digital data so as to extract positioning data of the vehicle 102. The local controller 310 recalls a database to parse the positioning data into toponym. In this embodiment, the database is installed in the memory 320 of the vehicle 102. The parsed toponym of the start place is stored in the memory 320 for later documentation or printing on a receipt. Optionally, voice prompt and display of the parsed toponym of the start place can be provided right away.

During the journey, the toponyms of POIs can be produced and stored in the memory 320 for later documentation or printing. In one embodiment, either the driver or the passenger can mark the POIs during the journey by pressing a button on the keypad 313. In another embodiment, a gyroscope or a similar inertial navigation device can be used to sense the driving direction of the vehicle 102 so as to detect a turning point or a crossroad as the POI. When a POI is confirmed, its corresponding toponym is then produced and stored, which is similar to the process of obtaining the toponym of the start place. Also voice prompt and display of the toponym can be provided optionally. There can be more than one POI during the journey, so the detecting and parsing processes can be repeated to obtain the toponyms corresponding to the POIs. When the journey is done, the path tracking course will be finished and a receipt for the journey can be produced. In one embodiment, by means of a specific button on the keypad 313, the destination can be confirmed by the operator's input. Certainly, the toponym of the destination can be parsed as well. In the end, the toponyms of the start place, POIs during the journey, and the destination, which are stored in the memory 320, are retrieved from the memory 320 and included on the electronic or paper receipt. Regular or additional information such as time, fare rate, and total fee can be included in the receipt.

Moreover, in accordance with other embodiments, additional modules can be added to the vehicle charge meter 300 for offering more functions. The additional modules can include a power conversion module, backup power supply module, protective module, black box service module, emergency alarm and help module, etc.

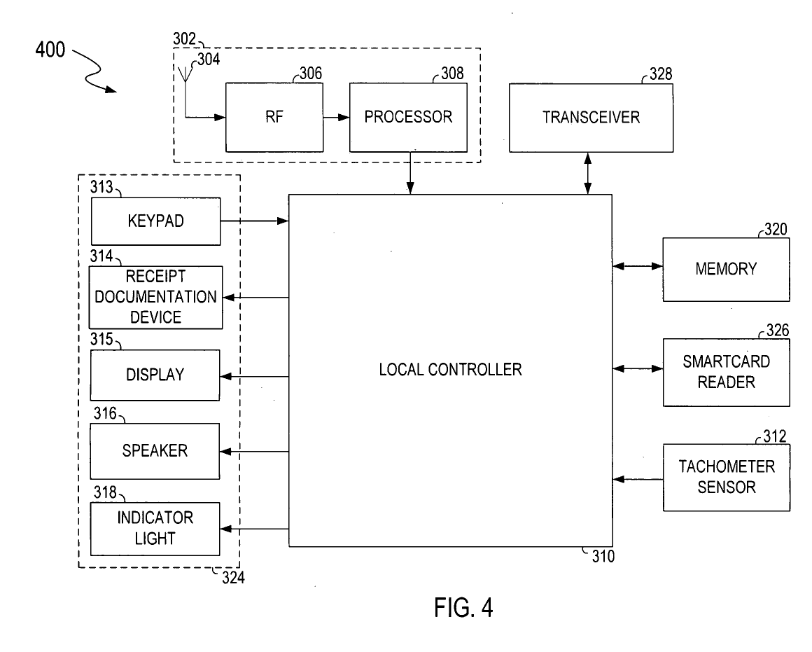

Referring to FIG. 4, another vehicle charge meter 400 for tracking a path of a vehicle according to one embodiment of the present invention is illustrated. The vehicle charge meter 400 is installed in the path tracking system 200 of the vehicle 102 shown in FIG. 2. In this embodiment, the vehicle charge meter 400 comprises a wireless transceiver 328 for communication with the remote server 108. For clarity, those elements of the vehicle charge meter 400 with the same element number as described above will not be described hereinafter in detail. In this embodiment, the database including mapping relationships between positioning data and their corresponding toponyms is installed in the remote server 108. As mentioned hereinabove, the remote server 108 can be used to transform the positioning data into toponyms, when a wireless communication between the vehicle 102 and the remote server 108 for data exchange is established. The transceiver 328 is used to establish the wireless communication. The transceiver 328 and the receiver 302 are used to process signals between RF signals and digital data. Therefore, the transceiver 328 has similar components as the receiver 302, which will not be described hereinafter in detail for purposes of brevity and clarity. The transceiver 328 is initially reset in an idle state. When in operation, the transceiver 328 sends a tracking command to the remote server 108. The tracking command includes positioning data received from the receiver 302 and command data for establishing a wireless communication. Then, the vehicle charge meter 400 of the vehicle 102 is set to a “waiting” status to wait a response from the remote server 108. In response to the tracking command, the remote server 108 extracts the positioning data from the command, and queries the database to retrieve the corresponding toponym. A tracking response with the corresponding toponym is then generated. When the remote server 108 sends out the toponym, the transceiver 328 receives and delivers the toponym to the local controller 310 for displaying, voice prompt, and receipt documentation and printing.

In foregoing embodiments, each element in the vehicle charge meter 300 and 400 is introduced separately as each itself is a separated component and can be formed as an isolated integrated circuit (IC) chip. For example, the local controller 310 can be a single chip. However, in accordance with other embodiments, some or even all of the modules can be integrated in one single chip according to different applications. For example, the memory 320 and the smartcard reader 326 can be integrated with the local controller 310 in one chip.

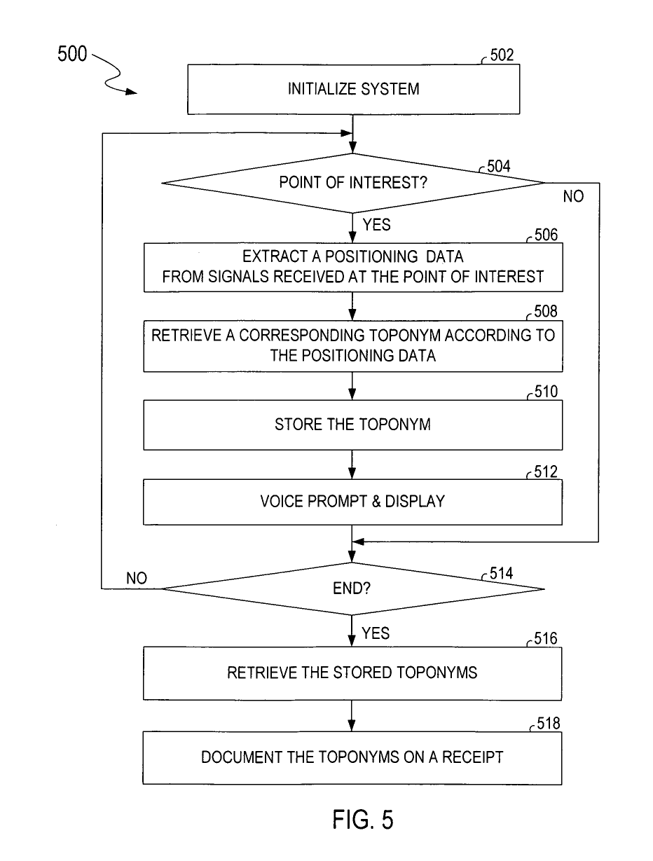

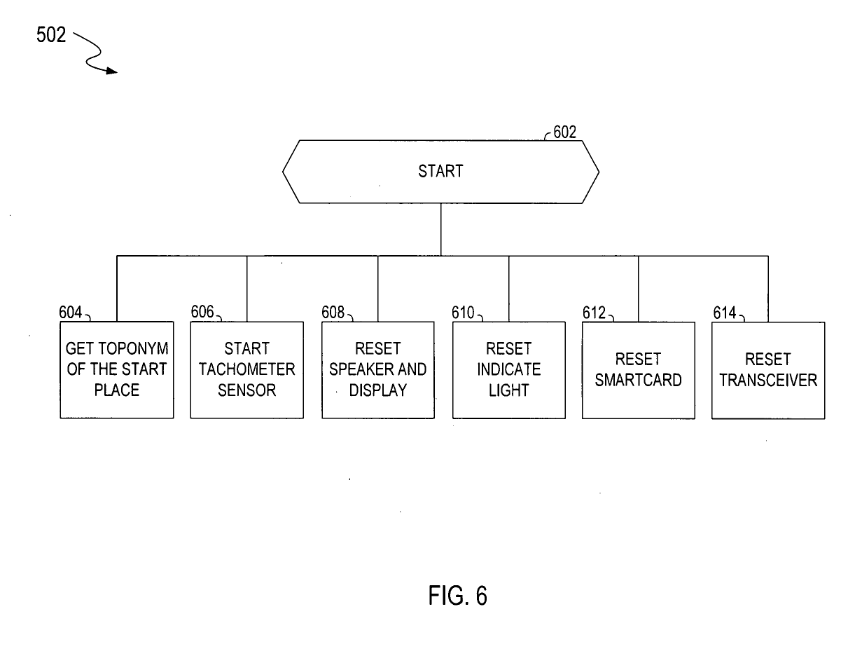

Referring to FIG. 5, a method 500 for tracking a path of a vehicle according to one embodiment of the present invention is illustrated. The method 500 can be implemented as software programs running in a local controller of a vehicle charge meter installed in the vehicle. The vehicle charge meter can further include a receiver, a tachometer sensor, a memory, a keypad, a speaker, a display, an indicator light, a receipt documentation device, and a smartcard reader. At 502, the vehicle charge meter is initialized. To trigger the vehicle charge meter, the driver as an operator can press a button on the keypad of the vehicle charge meter when a passenger gets on the vehicle. As long as the vehicle charge meter is triggered, previous records and temporary variables are cleared, and all the modules in the vehicle charge meter are configured, which will be described in more detail hereinafter in FIG. 6.

At 504, if a POI is passed, then the flowchart proceeds to 506; otherwise, the flowchart proceeds to 514. The particular places, such as turning points or crossroads, which can indicate the route of driving and influence the traveling distance and charge fee, can be automatically set as POIs. In one embodiment, a gyroscope or a like inertial navigation device can be used to sense the driving direction of the vehicle, and automatically detect and mark the turning point or crossroad as the POI. In another embodiment, either the driver or the passenger can choose wherever he/she is interested and press a button on the keypad to mark the place as a POI.

At 506, positioning data of the POI is extracted from GPS or LBS signals received at the POI. When the POI is confirmed at 504, signals from GPS satellites constellation, or from LBS cell sites, or even from other positioning information providers, are received. Raw data are extracted from the received signals. The desired positioning data of the POI can be calculated from the raw data. The calculated positioning data refer to geodetic coordinates of two dimensions: latitude and longitude, or even to an additional altitude dimension.

At 508, the toponym of the POI is retrieved from a database according to the positioning data. The corresponding toponym is parsed from the positioning data by querying the database and retrieving the corresponding toponym according to the positioning data. In one embodiment, the database is a look-up table including relationships between positioning data and toponyms. In other words, particular positioning data (geodetic coordinates) is correspondent to a unique corresponding toponym. In one embodiment, the database is installed in the vehicle.

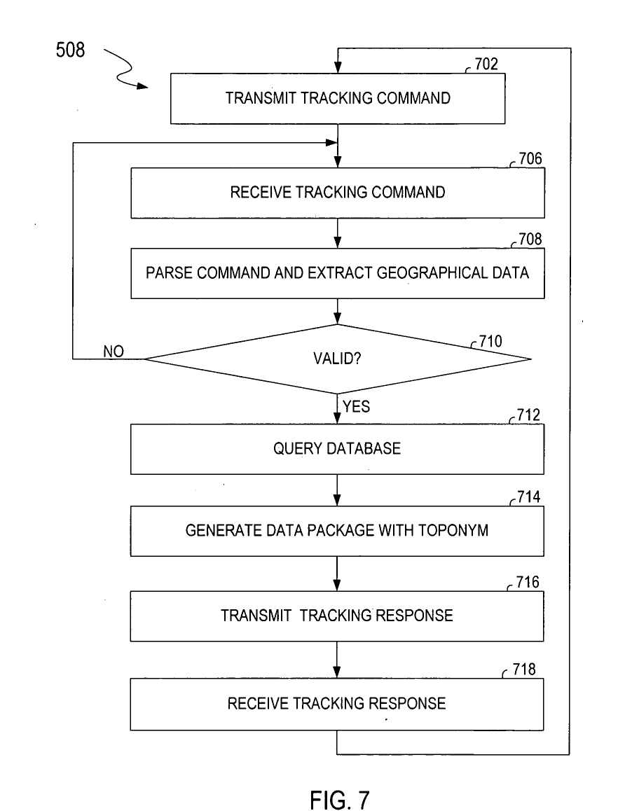

Yet in another embodiment, the database is installed in a remote server. In this situation, a wireless communication is built between the remote server and the vehicle. A transceiver is installed in the vehicle charge meter for communicating with the remote server and cooperating with the remote server to parse the toponym of the POI. The steps of retrieving the toponym from the database installed in the remote server are described in detail hereinafter with reference to FIG. 7. The vehicle charge meter and the remote server cooperate with each other to parse the toponym of the POI as shown in FIG. 7.

At 510, the parsed toponym of the POI is stored in a memory device in the vehicle for later receipt documentation or printing.

At 512, optionally, the voice prompt and the retrieved toponym display are provided in real time. Once the point POI is marked at 504, its toponym can be announced by the speaker and shown on the screen of the display.

At 514, whether the destination is arrived at is determined. If not, the flowchart returns to 504 for tracking another POI. There can be more than one POI during the journey, so the block 504 to the block 512 can be executed repeatedly. If the destination is confirmed, then the flowchart goes to 516.

At 516, the toponym of the destination is obtained, and a receipt can be produced. Similarly, the toponym of the destination can be obtained from the positioning data of the destination and the database. The detailed steps for parsing the toponym of the destination are similar to that of the POIs. The stored toponyms in the memory device as well as the toponyms of the start place and the destination can be retrieved for documentation or printing.

At 518, an electronic or paper receipt for the journey can be produced. The receipt documentation device is driven to produce the receipt with designed information. The content of the receipt can encompass the toponyms of the start place, POIs during the journey, and the destination, and information such as time, fare rate, and total fee according to different applications. For example, in one embodiment, the receipt documentation device can generate the electronic receipt in a form of a computer-readable .doc or .txt file, which can be downloaded to a mass storage device like a PDA, a smart phone, a USB flash disk, etc., or sent to a mobile phone as a SMS text message. In another embodiment, the receipt documentation device can be a printer printing out the paper receipt. As the traveling path of the journey is tracked clearly in the documented electronic receipt or the printed paper receipt, the passenger can check the journey afterwards. Once the passenger finds the route that the driver took is different from a normal or better one, he can lodge a complaint about the driver and ask for a refund, for example.

Referring to FIG. 6, a method of the block 502 for initializing the vehicle charge meter shown in FIG. 5 is illustrated, in accordance with one embodiment of the invention. At 602, the vehicle charge meter is triggered to start working. The modules of the vehicle charge meter are reset. At 604, the toponym of the start place where the passenger gets on the vehicle is produced by retrieving the toponym from the database according to positioning data of the start place. The detailed processes for parsing the toponym of the start place are similar to that for parsing the toponyms of the POIs, which are discussed hereinabove in relation to the block 506 to the block 512 in FIG. 5. The parsed toponym of the start place is then stored for further processing. At 606, the tachometer sensor is turned on and starts to count the traveling distance. At 608, the speaker and display is reset. At 610, the indicator light is turned off for indicating occupation of the vehicle. At 612, the smart card reader is reset ready for the current payment. At 614, in one embodiment, when a remote server is used to parse the toponym, a transceiver in the charge meter is reset to an idle state for communication with the remote server.

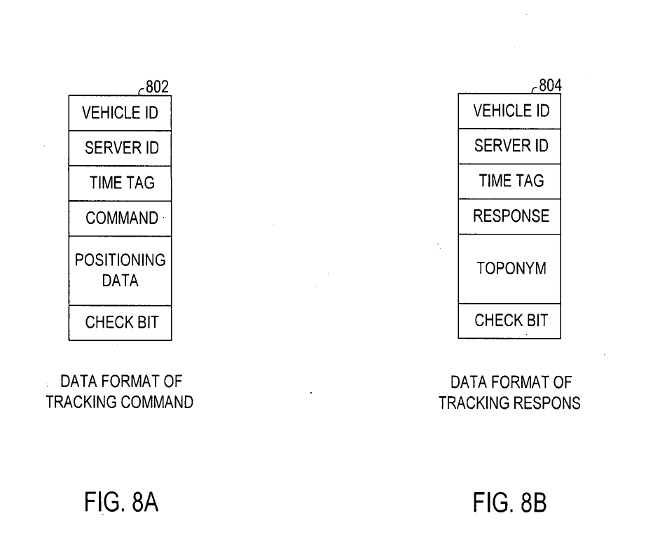

Referring to FIG. 7, a method of the block 508 for retrieving the toponym of the POI from the remote server is illustrated, in accordance with one embodiment of the invention. At 702, a tracking command is transmitted by the transceiver of the vehicle. In accordance with one embodiment of the present invention, a data format of the tracking command is illustrated in FIG. 8A. In response to the tracking command, a wireless communication is established between the vehicle and the remote server for exchanging data. The positioning data of the POI is packetized in the tracking command. Then, the vehicle is set to a “waiting” status to wait a response from the remote server. At 706, the tracking command is received by the remote server. At 708, the tracking command is parsed or analyzed by the remote server such that the positioning data carried is extracted. At 710, the validity of the tracking command is determined by the remote server according to the related information of the tracking command such as authenticating ID and check bit shown in FIG. 8A. If the tracking command is valid, the flowchart proceeds to step 712 directly; if not, then the flowchart returns to step 706 to wait for another tracking command. At 712, the database in the remote server is queried such that the toponym corresponding to the extracted positioning data can be retrieved. At 714, a package of a tracking response is generated by the remote server. In accordance with one embodiment, data format of the tracking response is illustrated in FIG. 8B. Vehicle ID, server ID, and the feedback toponym are carried in the package of the tracking response. At 716, the tracking response is transmitted back to the vehicle by the remote server. At 718, the transceiver receives the tracking response and extracts the toponym from the response package.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A vehicle charge meter for tracking a path of a vehicle, said vehicle charge meter comprising:
a receiver for receiving a plurality of signals and extracting positioning data from said plurality of signals;
a memory comprising a database storing relationships between a plurality of positioning data and a plurality of toponyms;
a local controller coupled to said receiver and said memory for retrieving at least one toponym from said plurality of toponyms corresponding to said extracted positioning data; and
a receipt documentation device coupled to said local controller for documenting said retrieved toponym.

2. The vehicle charge meter as claimed in claim 1, further comprising:
a tachometer for detecting a velocity of said vehicle; and
a timer for detecting a traveling time of said vehicle,
wherein said local controller is coupled to said tachometer and said timer for calculating a traveling distance and a total fare in accordance with said velocity and said traveling time of said vehicle detected, and said receipt documentation device documents said traveling distance, said traveling time, and said total fare.

3. The vehicle charge meter as claimed in claim 1, wherein said receipt documentation device comprises a printer printing out said retrieved toponym on a paper receipt.

4. The vehicle charge meter as claimed in claim 1, further comprising:
a speaker coupled to said local controller for audibly prompting said retrieved toponym.

5. The vehicle charge meter as claimed in claim 1, further comprising:
a display coupled to said local controller for displaying said retrieved toponym.

6. The vehicle charge meter as claimed in claim 1, further comprising:
a smart card reader coupled to said local controller for cashless payment.

7. The vehicle charge meter as claimed in claim 1, wherein said plurality of signals comprises a plurality of Global Positioning System (GPS) signals.

8. The vehicle charge meter as claimed in claim 1, wherein said plurality of signals comprises a plurality of location based service (LBS) signals.

9. The vehicle charge meter as claimed in claim 1, wherein said positioning data comprises geodetic coordinates of longitude and latitude.

10. The vehicle charge meter as claimed in claim 1, further comprising:
an inertial navigation device coupled to said local controller for automatically detecting a turning point of said vehicle, wherein a turning point toponym correspondent to said turning point is documented by said receipt documentation device.

11. A vehicle charge meter for tracking a path of a vehicle, said vehicle charge meter comprising:
a receiver for receiving a plurality of signals and extracting positioning data from said plurality of signals;
a local controller coupled to said receiver generating a tracking command including said extracted positioning data;
a transceiver coupled to said local controller for transmitting said tracking command to a remote server comprising a database, said database storing relationships between a plurality of positioning data and a plurality of toponyms, said transceiver also for retrieving a tracking response from said remote server, wherein said tracking response includes a toponym correspondent to said extracted positioning data; and
a receipt documentation device coupled to said local controller for documenting said toponym.

12. The vehicle charge meter as claimed in claim 11, wherein said transceiver communicates with said remote server through a wireless local area network (WLAN).

13. The vehicle charge meter as claimed in claim 11, wherein said transceiver communicates with said remote server through a Global System for Mobile communication (GSM) service.

14. The vehicle charge meter as claimed in claim 11, wherein said transceiver communicates with said remote server through a Code Division Multiple Access (CDMA) service.

15. A method for tracking a path of a vehicle, comprising:
receiving a plurality of starting point positioning signals at a starting point;
generating a starting point toponym corresponding to said starting point positioning signals received at said starting point;
choosing a point of interest (POI);
receiving a plurality of POI positioning signals at said POI;
generating a POI toponym corresponding to said POI positioning signals received at said POI;
receiving a plurality of destination positioning signals at a destination;
generating a destination toponym corresponding to said destination positioning signals received at said destination; and
documenting said starting point toponym, said POI toponym, and said destination toponym.

16. The method as claimed in claim 15, further comprising:
receiving a plurality of turning point positioning signals at a turning point of said path;
generating a turning point toponym corresponding to said turning point positioning signals received at said turning point; and
documenting said turning point toponym.

17. The method as claimed in claim 15, further comprising:
detecting said turning point automatically by an inertial navigation device.

18. The method as claimed in claim 15, further comprising:
audibly prompting said starting point toponym, said POI toponym, and said destination toponym; and
displaying said starting point toponym, said POI toponym, and said destination toponym on a display.

19. The method as claimed in claim 15, wherein said starting point positioning signals, said POI positioning signals, and said destination positioning signals are Global Positioning System (GPS) signals.

20. The method as claimed in claim 15, wherein said starting point positioning signals, said POI positioning signals, and said destination positioning signals are location based service (LBS) signals.

21. The method as claimed in claim 15, wherein said generating said POI toponym comprises:
querying a database in said vehicle storing relationships between a plurality of positioning data and a plurality of toponyms.

22. The method as claimed in claim 15, wherein said generating said point of interest toponym comprises:
transmitting a tracking command from said vehicle to a remote server;
querying a database stored in said remote server to generate said POI toponym in accordance with said tracking command;
generating a tracking response including said POI toponym; and
transmitting said tracking response from said remote server back to said vehicle.
